(19) United States
(12) Patent Application Publication
(10) Pub. No.: US 2010/0259620 A1
(43) Pub. Date: Oct. 14, 2010

(54) CCTV INCIDENT LOCATION SYSTEM

(75) Inventors: Kevin William Beggs, Lancashire (GB); Christopher Colin Anthony Woolley, Lancashire (GB); Nicholas John Easton, Essex (GB)

Correspondence Address: BUCHANAN, INGERSOLL & ROONEY PC, POST OFFICE BOX 1404, ALEXANDRIA, VA, 22313-1404, US

(73) Assignee: BAE SYSTEMS plc, London (GB)

(21) Appl. No.: 12/303,333

(22) PCT Filed: Oct. 23, 2008
(86) PCT No.: PCT/GB2008/003596

§ 371 Date: Sep. 29, 2009

(30) Foreign Application Priority Data
Oct. 22, 2007 (GB) 0720663.4
Oct. 23, 2007 (EP) 07254204.6

(51) Int. Cl. H04N 7/18

(52) U.S. Cl. 348/159; 348/E07.085; 381/92

(57) ABSTRACT

The present invention relates to a system for detecting incidents within an area covered by CCTV network. Specifically, the present invention relates to utilising detections of gunshots to autonomously direct CCTV cameras to cover an area in which a gunshot was detected.

The present invention provides a method for automatically directing CCTV cameras, wherein said CCTV cameras are each equipped with a microphone and are at known positions, comprising: filtering sounds received at each said microphone to detect a sound of a gunshot at at least three of the said CCTV cameras; triangulating a position of the gunshot from the three or more CCTV cameras known positions; and sending commands to the CCTV cameras around the position of the gunshot to point at the position of the gunshot.

The present invention relates to a system for detecting incidents within an area covered by CCTV network. Specifically, the present invention relates to utilising detections of gunshots to autonomously direct CCTV cameras to cover an area in which a gunshot was detected.

It is know to use triangulation to detect snipers in battlefield situations through the use of multiple microphones situated in multiple locations, recording a gunshot at each of these microphones and then mathematically determining from where the gunshot came and relaying this information to army personnel to intercept a sniper.

Additionally, in town centres and urban areas in general, there is normally a large CCTV network to allow the police and emergency services to identify and locate incidents occurring in city centres. There is a problem, however, as reports of incidents are delayed and those persons involved in those incidents can move out of the area covered by CCTV cameras near the area in which the incident took place. Thus, by the time the police and the emergency services have received the report of the incident, any person(s) connected with that incident will not be trackable by a CCTV system quickly and easily.

The present invention provides a method for automatically directing CCTV cameras, wherein said CCTV cameras are each equipped with a microphone and are at known positions, comprising: filtering sounds received at each said microphone to detect a sound of a gunshot at at least three of the said CCTV cameras; triangulating a position of the gunshot from the three or more CCTV cameras known positions; and sending commands to the CCTV cameras around the position of the gunshot to point at the position of the gunshot.

An advantage of the present invention is that persons involved in incidents can be located faster using the CCTV system of the present invention.

Specific embodiments of the invention will now be described, by way of example only and with reference to the accompanying drawings that have like reference numerals, wherein:—

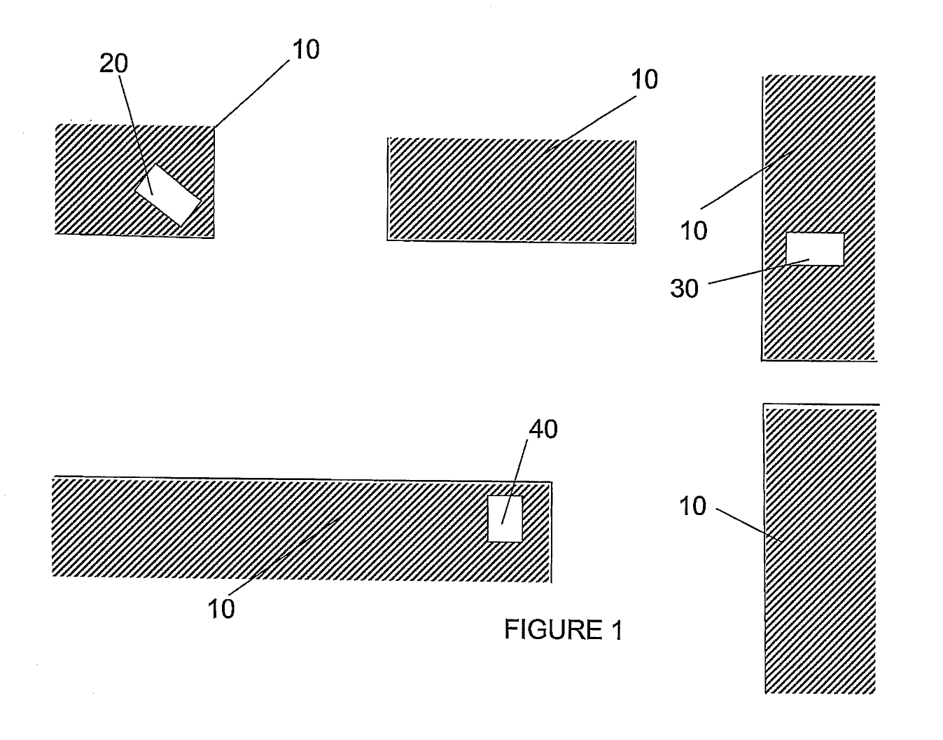

FIG. 1 shows a CCTV system in an urban area;

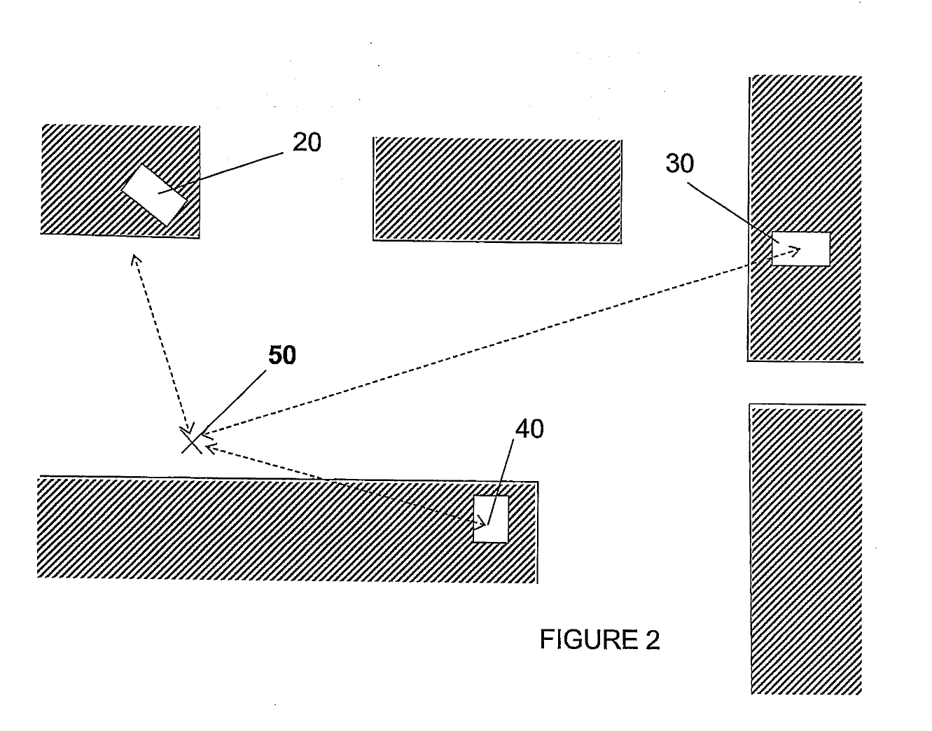

FIG. 2 shows a CCTV system according to the present invention monitoring an incident; and

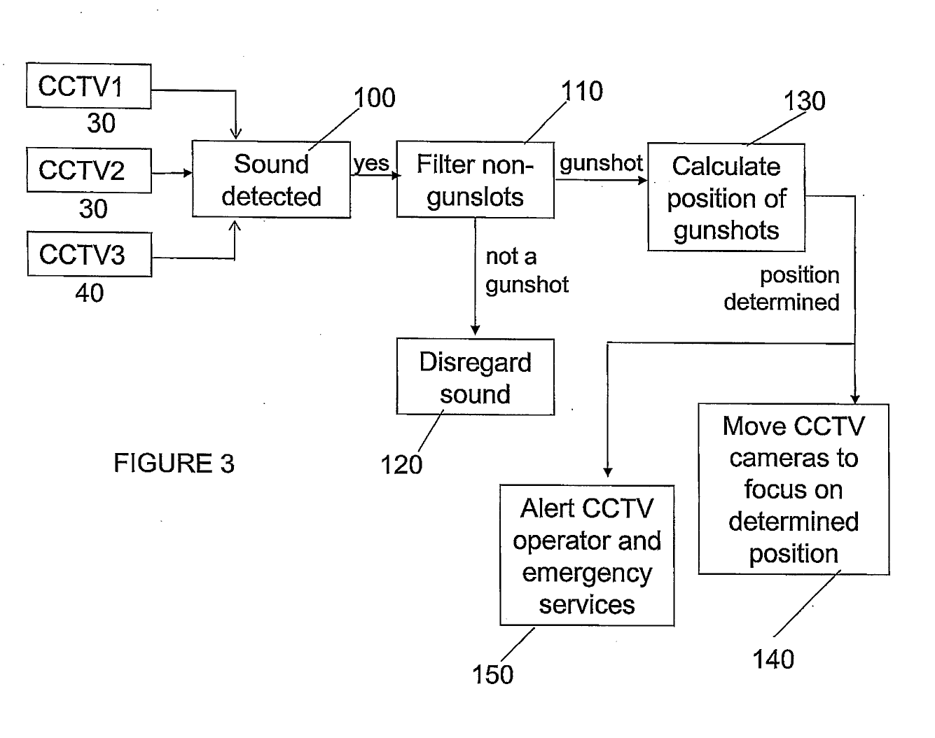

FIG. 3 shows a flow diagram of a method according to a preferred embodiment of the present invention.

The preferred embodiment of the present invention will now be discussed in relation to FIGS. 1 to 3:

FIG. 1 shows several buildings 10 in an urban area. On some of these buildings, CCTV cameras 20, 30, 40 are situated on moving mounts to allow them to be directed at different parts of the urban landscape.

Present CCTV surveillance systems require multiple cameras situated around, for example, urban areas. It is not, however, usually cost effective to have fixed CCTV cameras providing full video coverage of all open spaces in these areas so instead CCTV cameras are placed on directable mounts to decrease the density of CCTV cameras needed such that it is possible to aim at least one CCTV camera at any given space in the area covered by the CCTV camera system.

Thus, when an incident occurs involving a shot being fired, there may not be any CCTV cameras looking directly at the scene of the shot. Thus, it is necessary to direct relevant CCTV cameras to watch the area in and around where the shot was fired. As described above, this usually only occurs once a member of the public telephones the police to report their suspicions or, having witnessed the event, to describe what happened.

Thus, a CCTV camera according to the present invention incorporates a microphone which relays sound footage as well as the video footage from the camera back to the CCTV control centre, as shown in FIG. 2. When a sound such as a car backfiring, a person sneezing or a gunshot occurs within range of the microphone this will relayed back to the CCTV control centre.

In FIG. 2, the CCTV cameras 20, 30, 40 are mounted on buildings 10 surrounding an urban area. If a gunshot is fired at point 50, and the sound is recorded at the three CCTV cameras 20, 30 40 located around that point 50.

Referring now to FIG. 3, the audio feed from the three CCTV cameras 20, 30, 40 is run through a software filter for isolating discrete sounds 100 and a software filter 110 which can detect gunshots and disregard any sounds that are not gunshots. Once a gunshot is detected, the sound is matched up with the same sound recorded at at least two other CCTV cameras. Once a suitable number of detections of the same gunshot have been gathered, a known triangulation algorithm 130 is then applied based on the known positions of the CCTV cameras relative to each other.

It should be noted that any arrangement of filter/filters that can discern gunshots can be used, so if one filter can be used to both detect sounds and then filter out sounds that are not gunshots, then that is conceived to fall within the scope of the invention.

It should also be noted that many known gunshot sounds can be stored in a database from which the software filter 110 for detecting gunshots can match up with any gunshots fired in range of the microphones on the CCTV cameras 20, 30, 40 to detect a gunshot. This information can be passed on to the CCTV operators and the police, to assist them in locating the person who fired the gunshot.

Further, it should be noted that the audio/visual data streams from the CCTV cameras 20, 30, 40 are time-stamped to enable correlation between the times that the gunshot was heard at each camera. In enclosed spaces, it is possible that the gunshot will echo, so the first sound of the gunshot will be the relevant sound and the filter can be programmed to disregard echoes, as the same gunshot heard at the same camera may be an echo.

The triangulation algorithm 130 is performed at the CCTV control centre and outputs a position for the gunshot, together with some error estimates in the position, which enables the CCTV cameras in the area to automatically be directed 140 towards the area from which the gunshot was detected. This happens very shortly after the gunshot occurs and far faster then possible than a manual report being filed at the police and then relayed to the human operators of the CCTV control centre who then have to determine which cameras are nearby in order to redirect them.

Further, the triangulation algorithm 130 can also report the gunshot incident directly to the emergency services 150, together with a location and details of the most likely type of gun used, so for instance the police and ambulance services can be directed to the location rapidly. Still further, the triangulation algorithm 130 can highlight the cameras that are now directed towards the incident to the CCTV camera operators who can then take over monitoring of the situation from the automatic redirection system of the invention.

It is also conceived that the CCTV cameras in the surrounding areas can be directed to cover the exit routes from the area in which the gunshot was detected, to allow the CCTV operators to track those involved in the incident.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1-7. (canceled)

8. A method for automatically directing CCTV cameras, wherein said CCTV cameras are each equipped with a microphone and are at known positions, comprising:
filtering sounds received at each said microphone to detect a sound of a gunshot at at least three of the said CCTV cameras;
triangulating a position of the gunshot from the three or more CCTV cameras known positions; and
sending commands to the CCTV cameras around the position of the gunshot to point at the position of the gunshot.

9. A method according to claim 8, further comprising communicating the position of the gunshot to one or more emergency services.

10. A method according to claim 8, wherein a visual alert is provided to an operator of the CCTV camera system to draw attention to the location of the gunshot.

11. A method according to claim 8, further comprising communicating one or more possible types of gun used to fire the gunshot to one or more emergency services.

12. A method according to claim 8, wherein commands are also sent to the CCTV cameras covering the exits from the area around the position of the gunshot to point at said exits.

13. A method according to claim 9, wherein a visual alert is provided to an operator of the CCTV camera system to draw attention to the location of the gunshot.

14. A method according to claim 13, further comprising communicating one or more possible types of gun used to fire the gunshot to one or more emergency services.

15. A method according to claim 8, wherein commands are also sent to the CCTV cameras covering the exits from the area around the position of the gunshot to point at said exits.

16. A system operable to automatically direct CCTV cameras, wherein said CCTV cameras are each equipped with a microphone and are at known positions, comprising:
a filter for filtering sounds received at each said microphone to detect a sound of a gunshot at least three of the said CCTV cameras;
a processor for triangulating a position of the gunshot from the three or more CCTV cameras known positions and for sending commands to the CCTV cameras around the position of the gunshot to point at the position of the gunshot.

17. An apparatus operable to automatically direct CCTV cameras, wherein said CCTV cameras are each equipped with a microphone and are at known positions, comprising:
a filter for filtering sounds received at each said microphone to detect a sound of a gunshot at least three of the said CCTV cameras;
a processor for triangulating a position of the gunshot from the three or more CCTV cameras known positions and for sending commands to the CCTV cameras around the position of the gunshot to point at the position of the gunshot.

18. A method according to claim 9, wherein commands are also sent to the CCTV cameras covering the exits from the area around the position of the gunshot to point at said exits.

19. A method according to claim 10, wherein commands are also sent to the CCTV cameras covering the exits from the area around the position of the gunshot to point at said exits.

20. A method according to claim 11, wherein commands are also sent to the CCTV cameras covering the exits from the area around the position of the gunshot to point at said exits.

21. A method according to claim 12, wherein commands are also sent to the CCTV cameras covering the exits from the area around the position of the gunshot to point at said exits.

22. A method according to claim 13, wherein commands are also sent to the CCTV cameras covering the exits from the area around the position of the gunshot to point at said exits.

23. A method according to claim 14, wherein commands are also sent to the CCTV cameras covering the exits from the area around the position of the gunshot to point at said exits.
